(19) United States
(12) Patent Application Publication
(10) Pub. No.: US 2020/0208672 A1
(43) Pub. Date: Jul. 2, 2020

(54) Apparatus and Method to Establish Two Reference Positions Within a Fastener In Order to Allow the Measurement and Monitoring of Fastener Load

(71) Applicant: Cory Sean Waxman, Phoenix, AZ (US)

(72) Inventor: Cory Sean Waxman, Phoenix, AZ (US)

(21) Appl. No.: 16/731,829

(22) Filed: Dec. 31, 2019

Related U.S. Application Data
(60) Provisional application No. 62/787,045, filed on Dec. 31, 2018.

(51) Int. Cl. F16B 31/02; G01L 5/24

(52) U.S. Cl. CPC F16B 31/025; G01L 5/24

(57) ABSTRACT

The present apparatus provides an assembly that can be inserted into an open ended bore along the central axis of a fastener. The assembly can be used to continuously monitoring clamp load (tensile force) status throughout the life of a fastener and is attached at positions that help to reduce or eliminate problems that occur in existing load indicating fasteners that are associated with yielding, unknown force distribution, or stress versus elongation relationships occurring in non-uniform sections of a fastener. The apparatus has a design which makes it simple and inexpensive to manufacture and install.

### CROSS-REFERENCE TO RELATED APPLICATIONS

U.S. Provisional Patent No. 62/787,045

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

Fasteners are used in a wide variety of applications, such as motors, railroad tracks, flange assemblies, petrochemical lines, foundations, mills, drag lines, power turbines, and studs on cranes and tractors. In many applications, achieving the proper fastener tightness (also referred to as tension or load) and maintaining this tightness once the system is placed in service is problematic. If the tensile load becomes too great, it can increase to a maximum break point (i.e. where the fastener breaks or its integrity is otherwise compromised) and if the tensile load is too low, other nearby fasteners may experience too much tensile force and tensile strain as a result. For many applications, the theoretically desired fastener tensions are known, but currently available methods, apparatus, and devices do not adequately enable reliable, repeatable, and/or cost-effective determinations of the actual tensile force of a fastener during the installation and service of a fastener.

When placed in service, fasteners typically experience a loss of tension due to a variety of in-service occurrences such as relaxation (thread embedment), vibration loosening, compressive deformation in the joint or flange, temperature expansion or contraction, etc. The loss of tension that results from these occurrences can cause premature wear in the assembly, leakage (in applications where the fastener is used for sealing), or catastrophic joint failure due to excessively high loads on other members of the assembly. Improper tension can also lead to fatigue failures. Thus, in many applications, knowledge of a fastener load (tightness), initially and over time, is desirable for avoiding such potentially dangerous consequences of a loosened fastener. In some applications, for example when working with a plurality of bolts around a flange, it is important to evenly tighten the group of bolts. By accurately and uniformly tightening a group of bolts or studs to an appropriate load, and maintaining this load over time, potential failures are less likely to be experienced.

Traditional practices attempt to use torque measurements to determine tensile force. Torque is relatively easy to control during fastener installation, however, it is well known in industry and academia that the relationship between torque and tensile force is not consistent nor predictable. For instance, with this method, the frictional force between the fastener and the threaded nut or hole must be considered; this frictional force depends upon, and varies according to, the quality of the fastener or hole threads, lubrication, oxidation, material coatings, temperature, and (non-parallel) surface orientation in the joint. As these variables can not be controlled easily or at all, the torque measurement, therefore, can not be an accurate method of obtaining a desired tensile force.

In addition to the problems of using torque to control tensile force, there exist other common problems with conventional tightening methods that are described and explained in detail in PCT application of the present inventor, hit. Pub. No. WO 99/49289 published Sep. 30, 1999. Some of these problems will be described now such as the fact that conventional methods provide little or no information on the loss of tension after the assembly process. For example, fasteners typically experience a loss of tension when put into service for a variety of reasons including local yielding and relaxation, vibration loosening, gasket creeping out of the joint, and thermal expansion. This unmonitored loss of tension can lead to serious problems such as joint slippage, premature wear, and joint failure. Users wanting to maintain tension must often use cumbersome methods to check the tightness of each bolt, or simply attempt to re-tighten all of the fasteners regardless of whether such re-tightening is needed. The re-tightening (retorquing) of fasteners can be time consuming, expensive, and can unnecessarily induce additional wear and strain in the fastener system. Design engineers compensate for the uncertainty in fastener tension by overdesigning joints and having large safety factors. Overdesigning fasteners is not only an expensive strategy, in cases where accuracy and uniformity is necessary, it is not a viable solution to the problem of inaccurate fastener tensions in an assembly.

Another common method of determining tensile force is to analyze strain (elongation) of the tightened fastener rather than installation torque. Strain may be measured through the use of mechanical, electrical, opti-mechanical, ultrasonic methods, and the like, and various load indicating fasteners using each of these methods are known. See, for example, U.S. Pat. No. 4,676,109 issued Jun. 30, 1987 to Wallace, U.S. Pat. No. 5,388,463 issued Feb. 14, 1995 to Scott, and U.S. Pat. No. 2,600,029 issued Jun. 10, 1952 to Stone, each disclosing fasteners including various electronic measurement devices and apparatus; U.S. Pat. No. 4,899,591 issued Feb. 13, 1990 to Kibblewhite disclosing an ultrasonic load indicating member; and U.S. Pat. No. 4,823,606 issued Apr. 25, 1989 to Milecki disclosing a diaphragm transducer for sensing load.

Typically, these methods are not usable by ordinary workers. For example, electronic or ultrasonic methods for determining existing tensile force may require experienced operators, expensive equipment, clean surfaces, and records of pre-installation test values for each bolt or stud. Experienced operators must perform numerous calculations to obtain the clamp load, while compensating for deformations in the head of the fastener. Moreover, devices and apparatus which may include complicated electronics tend to add to the expense, maintenance, and unreliability of the system. In addition, such systems may be adversely affected by shock and other extreme conditions.

Other prior art devices include color indicators which denote the load changes within the fastener by changes in the color of the indicator. See, for example, U.S. Pat. No. 3,987,668 issued Oct. 26, 1976 to Popenoe, U.S. Pat. No. 3,823,639 issued Jul. 16, 1974 to Liber, and U.S. Pat. No. 3,964,299 issued Jun. 22, 1976 to Johnson. These indicators may require interpretation of the color designation and only indicate when a load exists. Determination of intermediate load levels, or partial loosening of a fastener, is not possible. Furthermore, because most fasteners are in-service in an outdoor environment, variations in sunlight may restrict an inspector's ability to determine the specific color of the indicator.

Another class of prior art on the market allows users to directly measure strain and tensile force during and after the initial installation of a fastener by monitoring the movement of a gauge pin that is anchored (attached) within an open ended central bore along the axis of the fastener. See, for example, U.S. Pat. No. 5,668,323 issued Sep. 16, 1997 to the present inventor, U.S. Pat. No. 6,204,771 issued Mar. 20, 2001 to Ceney, U.S. Pat. No. 3,943,819 issued Mar. 16, 1976 to Charron, and U.S. Pat. No. 2,995,033 issued Aug. 8, 1961 to Stifano.

These devices with an anchored (attached) gauge pin typically depend upon two points which are used as reference points in the strain measuring process. The distance between these two points is called the gauge length. As is well known and shown in FIG. 1a and FIG. 1b the reference point A is approximately at the end of the fastener. Typically the strain gauge is attached to the fastener at or near this point A. The second reference point, B, is located near the bottom of the hole drilled through the axis where the gauge pin is attached (the pin is typically attached through means of press fit, interference fit, weld, adhesive, or a combination of these means.

The process of making a strain measurement involves comparing the changing distance between the two reference points to the original distance, i.e., the original gauge length. As shown in FIG. 1 (the effect is exaggerated since this elongation is very small), when the bolt is tightened, the reaction forces from the joint and nut cause the bolt to stretch elastically (in most applications the body of the bolt will experience stresses in the elastic region, safely below the yield point). This measured elongation can be converted to stress levels and bolt clamping force by using the known elastic modulus of the material and basic engineering equations. The amount of the elongation is typically very small, for example, a 1″ grade 5 bolt tightened to the ASTM specified maximum safe load (proof load) will experience only a few thousandths of an inch elongation per inch. This elongation causes several potential problems, including yielding (permanent deformation) of bolt heads and fastener ends, non-uniform stretching which occurs at the end sections of the fastener and where the nut engages a stud, and the changing position of the nut for applications involving studs. Strain gauged bolts often become inaccurate after an initial assembly or while in service. Often, after the bolt is removed and inspected, the strain gauge will indicate tension in the fastener even though no tension is present. The false indications are likely related to a slight yielding in the head or end of the fastener.

As is well known, yielding commonly occurs in bolt heads even when the clamping force is well below the specified capability of the bolt. That is, the head often experiences permanent deformations even when the body of the bolt is at stress levels well below the yield point of the material.

One common condition that leads to such yielding can occur when the head of the fastener sits on a surface that is not perpendicular to the axis of the bolt. As is well known and shown in FIG. 2a-c, as the bolt is tightened, one part of the head experiences a high reaction force, creating a prying effect (also well known as a wedge effect). These uneven forces can cause yielding and permanent deformation even when the body of the bolt is at stress levels within the elastic region and thus not experiencing yielding.

Another condition which can produce yielding in the head is shown in FIG. 3a-c and occurs when the hole upon which the bolt head lies is too large. In this situation, the contact force between the head of the bolt and the mating surface is concentrated in a small area. Again, this produces high stress levels and local yielding in the head.

Additionally, because they typically contain a bore, fasteners with internal strain gauges tend to have weakened ends. Since they are weakened, they have an increased susceptibility to both of these types of yielding in the head region. Although yielding in the head is generally not a problem in non-strain-gauged-bolts, in strain-gauged-bolts, it can cause many problems and lead to significant inaccuracies. These problems arise because of the nature of the strain measuring process. As described earlier, the strain measurement is made by comparing the gauge length of the unstrained bolt to the gauge length of the strained bolt. The difference between these two lengths is the elongation. Elongation is generally very small, i.e., on the order of only a few thousands of an inch per inch.

As is well known and shown in FIG. 2 and FIG. 3, the gauge length of the unstressed bolt can be changed due to the yielding. Any change in the gauge length of the unstressed bolt must be accounted for when determining the elongation. Since one of the reference points is at the end of the fastener, yielding in this end can result in a changed unloaded distance between the two reference points that will change the gauge length of the unstressed bolt. If the change in the gauge length of the unstressed bolt is not accounted for, errors in the displayed tension can occur. For example, the bolt could self-loosen to zero tension, while the strain gauge still measures the residual strain (permanent elongation due to yielding) and falsely convert this to a stress or tension. In general, if the changed reference length is not accounted for, then all of the calculated stress levels will be inaccurate.

Many commonly used strain measuring devices offer no method to account for a changed reference length and thus can not be relied upon after the initial assembly. Further, in cases where there is a method to determine or adjust for this problem, the procedure for doing so is generally inconvenient. In order to make this adjustment, it is typically necessary to remove the tension from the fastener. However, removing the tension is typically either not possible or prohibitively burdensome as it usually involves taking the fastened joint or machinery out of service.

Another well known common fastener problem arises when attaching a strain gauge to the end of a stud (a non-headed fastener). In particular, the final position of the nut on the stud after installation will directly affect the length of the strained region. To understand this, consider FIG. 4a and FIG. 4b. The Figures show a stud with nuts in two positions. Since the region between point A and B is unstrained, the strained region must be located between points B and D. However, the exact region subjected to strain is very unclear and relies upon at least two variables: (1) the respective distances between A and D and between B and D, and (2) the cumulative effect of non-uniform forces on the stud by the nut.

The distance between A, the upper surface of the stud, and B, the upper surface of the nut, is commonly called the nut standoff. In most bolting applications, little attention is paid to precisely controlling and/or maintaining this distance. Many variables will affect the nut standoff as shown in FIG. 5A and FIG. B, such as, for example, the overall length of the fastener, the amount of thread engagement of the nuts, the height of the nuts, variances in the dimensions of the joint and gasket, and the dimensions of any washers. A second variable affecting the length of the strained region involves the non-uniform forces exerted on the stud by the nut. In general, the greatest contact forces occur in the lower threads, and the contact forces decrease to approximately zero at the uppermost thread (point B). The exact distribution varies for each individual stud and nut combination and depends upon the exact dimensions, the exact thread pitch, the hardness of the parts, the wear of the parts and the tension in the fastener.

Furthermore, for an individual nut and stud, the force distribution will change over time. As the first few threads experience the highest load, in service they will often yield. Thus, nearby threads may exert greater contact forces on the stud over time or upon reassembly. Such unknown and changing force distributions make it impossible to know exactly where the yield should be located between points B′ and C in FIG. 4 and FIG. 5. Since this end of the stretched section is not known, the exact length of the stretched region is not known.

The combined effect of these two variables, and particularly the variations in the standoff can lead to significant problems in the strain monitoring process. Although elongation can still be measured, in order to convert this elongation to a stress level it is necessary to know the length of the strained region. To address this problem, the user can attempt to control the standoff in the field. However, this can be a prohibitively time consuming process that may require the removal of the nut and the insertion or removal of spacing washers, or the adjusting of thread engagement of the nuts which may involve at least a partial dismantling of the joint. Further, the retraining of already experienced operators to pay close attention to nut standoff is a problem. In most bolt assembly operations, the emphasis is on speed, and there is a great resistance to more complicated assembly procedures.

Products using this anchored gauge pin can measure and indicate the elongation of a predetermined section of the fastener as it is tightened. In this method, the elongation of the fastener will cause relative movement between the free end of the gauge pin and a second reference surface which is usually at or near the end of the fastener. This movement or change of position can be measured electronically or through a mechanical gauge.

Products utilizing gauge pins with built-in or removable gauges and sensors are prohibitively expensive for most applications. In many cases, the significant expense of these load indicating fasteners is due to the expensive gauges or sensors used, as well as the cost of complicated machining, installation and calibration procedures necessary to retrofit the fastener. In some cases, these devices require custom made fasteners in order to have the necessary head strength or in order to interface with a gauge. Nearly all of the available gauge pin apparatus involve machining processes that may include three or more different diameter bores in the fastener as well as other operations. In many cases, it is also necessary to grind the head of the fastener or a protrusion on the head of the fastener flush with the free end of the gauge pin. The operations described above are generally performed by the manufacturing company of the fastener as these machining and installation procedures are beyond the capabilities of most end users.

Because the prior art devices, apparatus, and methods are either inaccurate, prone to inherent problems that lead to inaccuracies, time consuming to install, time consuming to use, require leaving a sensitive instrument in a rugged environment, or prohibitively expensive for most applications, a need exists for a tension indicating device and method that can easily and reliably measure and monitor a known length of a fastener by anchoring to, and then comparing the positions of, two known and predetermined reference points within the fastener. Additionally, a need exists to monitor tension in a fastener with an apparatus that is simple to use, easy to manufacture and install, and inexpensive.

### BRIEF SUMMARY OF THE INVENTION

The present apparatus provides an assembly for continuously monitoring clamp load (tensile force) status throughout the life of a fastener. The present apparatus provides an assembly which is comprised of a gauge pin and a tubular base piece that can be installed into a hole along the central axis of a fastener. The apparatus attaches at two positions within the hole. The distance between these two positions is predetermined and changes in this distance can be measured and used to determine the strain and tension of the fastener. The present apparatus may involve very little machining to an existing fastener and the retrofitted fastener does not require the addition of a custom head or end. In most cases, the ultimate strength of the fastener may not be compromised because the minimum cross-sectional area (the weakest region) of the fastener may still occur in the threaded region and not in the region where the present apparatus is installed. The present apparatus also overcomes specific problems inherent in the design of many existing load indicating fasteners. These problems include, but are not limited to, problems associated with yielding, unknown force distribution, stress versus elongation relationships occurring in non-uniform sections of a fastener, complicated machining process required on the fastener and the load indicating device, the need for custom fasteners, complicated installation procedures, fragile devices that are prone to failure in rugged environments, and time-consuming calibration procedures. Thus, the present apparatus is unprecedented in its simplicity to manufacture and install while remaining durable and reliable.

### BRIEF DESCRIPTION OF THE SEVERAL VIEWS OF THE DRAWINGS

FIG. 1A shows an untensioned fastener in a bolted joint and two points that can be used for measuring strain.

FIG. 1B shows a tensioned fastener in a bolted joint and the new distance between the two points that can be used for measuring strain.

FIG. 2A shows an untensioned fastener in a bolted joint with an angled surface.

FIG. 2B shows a tensioned fastener in a bolted joint with an angled surface.

FIG. 2C shows the resulting permanent deformation of the fastener head.

FIG. 3A shows an untensioned fastener in a bolted joint with an oversized hole.

FIG. 3A shows a tensioned fastener in a bolted joint with an oversized hole.

FIG. 3C shows the resulting permanent deformation of the fastener head.

FIG. 4A shows a stud with a nut in a first position and depicts a first length from the bottom of the hole to the nut

FIG. 4B shows a stud with a nut in a second position and depicts a different resulting length from the bottom of the hole to the nut

FIG. 5A shows an assembly with washers present and depicts a length from the bottom of the hole to a nut.

FIG. 5B shows an assembly with washers present and depicts a different resulting length from the bottom of the hole to a nut.

FIG. 6 depicts a tubular base piece and gauge pin inserted into an open ended bore in a fastener.

FIG. 7A depicts the distance between two reference points along the central bore of an untensioned fastener.

FIG. 7B depicts the new distance between two reference points along the central bore of a tensioned fastener.

FIG. 8A depicts an untensioned fastener with a housing and sensor measuring the relative positions of two reference surfaces at the end of the untensioned fastener.

FIG. 8B depicts a tensioned fastener with a housing and sensor measuring the new resulting relative positions of two reference surfaces at the end of the tensioned fastener

FIG. 9A depicts an untensioned fastener with a three piece system that includes a tubular sleeve which during installation is used to maintain a known distance between where the gauge pin attaches to the fastener and where the tubular base attaches to the fastener.

FIG. 9B depicts a tensioned fastener with a three piece system that includes a tubular sleeve which during installation is used to maintain a known distance between where the gauge pin attaches to the fastener and where the tubular base attaches to the fastener.

FIG. 10 depicts a gauge with a symmetrical protrusion attached to, or a part of, the gauge pin, causing interference that will establish a known gauge length during installation of the device.

FIG. 11 depicts a gauge with a non-symmetrical protrusion attached to, or a part of, the gauge pin, causing interference that will establish a known gauge length during installation of the device.

FIG. 12 depicts a tubular base piece and gauge pin inserted into an open ended bore of uniform diameter in a fastener.

FIG. 13A depicts the present invention used in conjunction with a load indicating sensor residing primarily within the fastener.

FIG. 13B depicts a second configuration where the present invention used in conjunction with a load indicating sensor residing primarily within the fastener.

FIG. 14 depicts a bolted joint with a threaded studs where the points of attachment of the tubular base piece and the gauge pin are below the nut.

FIG. 15 depicts an assembly with a protective cap

FIG. 16 depicts a second assembly with a protective cap

FIG. 17 depicts a configuration where a measuring sensor can send a signal to a receiver. The figure also depicts a tightening device that can be controlled with hard wires or wirelessly.

### DETAILED DESCRIPTION OF THE APPARATUS

The following description is of example implementations of the invention only, and is not intended to limit the scope, applicability or configuration of the invention. As will become apparent, various changes may be made in the function and arrangement of the elements described in these implementations without departing from the scope of the invention as set forth herein

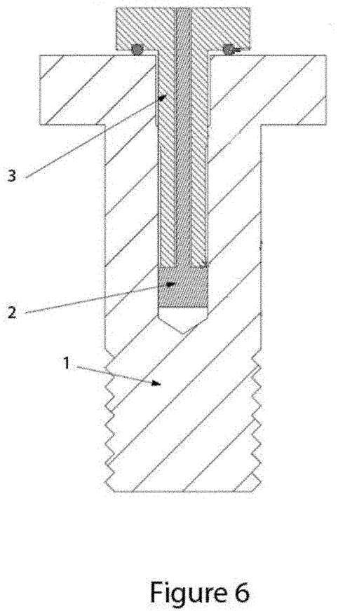

With reference to FIG. 6, this apparatus is a gauge pin 2 having a non-uniform diameter, or having a protrusion, within a tension indicating assembly comprised of two or more pieces such that one piece is a tubular base 3 and one piece is the gauge pin 2, and where both pieces 2, 3 are inserted into a central bore of a tensile member 1 in which the tension is to be monitored. This tensile member 1 may typically be a threaded fastener, such as a bolt or stud, but does not need to be a threaded fastener. Part of the gauge pin 2 may pass through the tubular base 3. Both the tubular base 3 and the gauge pin 2 may be fixed to the fastener within the central bore at specific locations (PT. A shows the region where the base could be attached and PT. B shows the region where the pin could be attached). The means of attachment could be a press fit, adhesive, interference fit, weld or other means.

There are various methods that could be used for manufacturing the gauge pin 2. In fact, the gauge pin is very similar to ejector pins commonly used in plastic injection molding equipment. The larger diameter can be forged, or the smaller diameter can be turned down in a lathe process. In any case, it is preferred to make a gauge pin 2 with a similar coefficient of thermal expansion as the fastener. The tubular base 3 may also be manufactured with various well known methods such as drilling the central bore and turning the outside surfaces on a conventional lathe. It would also be possible to manufacture the gauge pin 2 and the tubular base 3 with a 3-D printer.

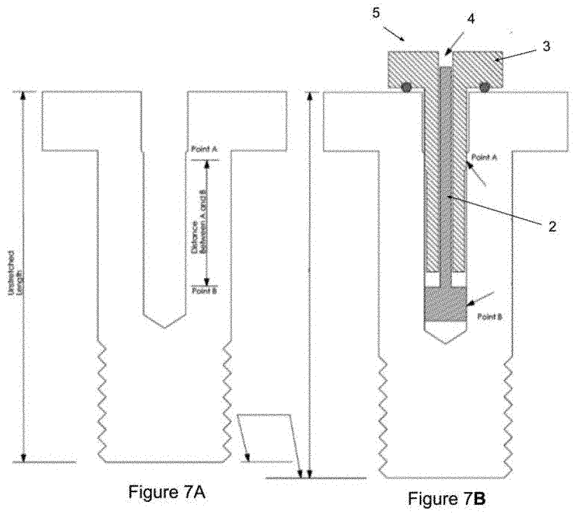

With reference to FIG. 6, FIG. 7a,b shows that when tensile member 1 is under stress, it may stretch such that the distance between PT. A and PT. B increases. As the distance between PT. A and PT. B increases, since the tubular base 3 and the gauge pin 2 may not stretch, the pin upper surface 4 will move relative to the tubular base upper surface 5 as depicted in FIG. 7b. The amount that the pin upper surface 4 moves relative to the tubular base upper surface 5 may be the same as the increase in distance between PT. A and PT. B. (This distance is exaggerated FIG. 7 and is typically only several thousands of an inch.)

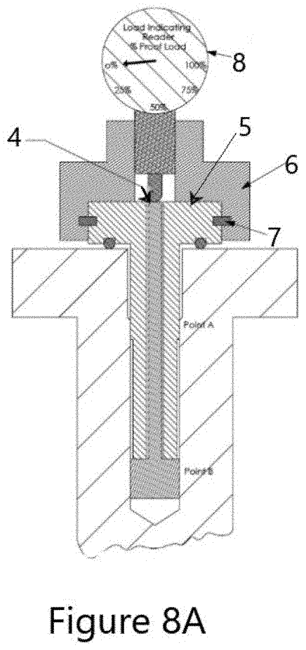

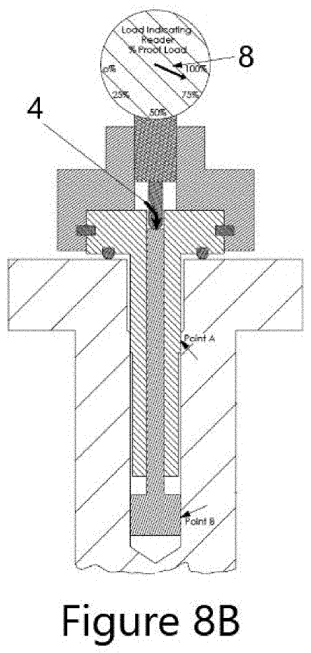

The amount of increase in the distance between PT. A and PT. B when the tensile member is tensioned can be determined (FIG. 8a,b) by measuring the change of position between the pin upper surface 4 relative to the tubular base upper surface 5.

In this apparatus, the gauge pin 2 may be made such that it may have two diameters or some other protrusion, such that during installation of the apparatus, the interference and forces between the gauge pin 2 and the tubular base 3 may establish or maintain a desired distance between the PT. A on the tubular base 3 and the PT. B on the gauge pin 2. For example, during installation, while pressure is applied to the upper surface of the tubular base 2 to press or otherwise force it into position at PT. A within the tubular bore, a bearing surface on the tubular bore may simultaneously press the gauge pin 2 to the appropriate attachment position at PT. B.

In another installation scenario, the gauge pin 2 could first be pressed into the tubular bore of the tensile member 1 and then the tubular base 3 could be inserted into the bore and pressed until it interfered with the larger diameter on the gauge pin 2 or with a protrusion on the gauge pin 2. In any of the installation scenarios, a second diameter or a protrusion on the gauge pin 2 may physically bear against, or interfere with, a part of the base piece 3 such that a desired distance between PT. A and PT. B can be achieved or maintained during the installation of the apparatus.

Additional embodiments of this apparatus will now be described and some of these descriptions will correspond to specific drawings and figures.

FIGS. 8A and 8B show a sensor, which can be mechanical or digital. The sensor could mechanically measure 4 the position of the upper surface of the gauge pin 2 relative to 5 the upper surface of the tubular base 3. The sensor could also electronically sense the distance through non mechanical means such as using a circuit to measure changing inductance or capacitance in an air gap or by using sound or electromagnetic waves to reflect off of the top of the gauge pin 2. This sensor could be attached to the tubular base 3 or to the fastener 1 with a housing 6. The housing 6 could be attached with the aid of a recess 7 in the tubular base 3 which could assist in the precise locating of the sensor housing 6. The housing 6 could also attach to the tubular base piece 3 by using a coupling system using a series of movable rings or mechanical pieces similar well known coupling methods such as is used by some quick release pneumatic air hoses. A magnetic force could also be used to attach the sensor housing 6 to the tubular base 3. The sensor housing 6 could also be attached through a threaded interface. While the sensor 8 depicted in FIG. 8A and FIG. 8B shows the percent of proof load, alternative scales or simply colors could be used to indicate the tensile load of the fastener. While FIG. 8A and FIG. 8B show this measurement being made with the use of the housing 6, a measurement could also be made without the use of the housing 6. In this scenario a standard depth micrometer or other measuring device could be placed directly against the tubular base piece to measure 4 the position of the upper surface of the gauge pin 2 relative to 5 the upper surface of the tubular base 3.

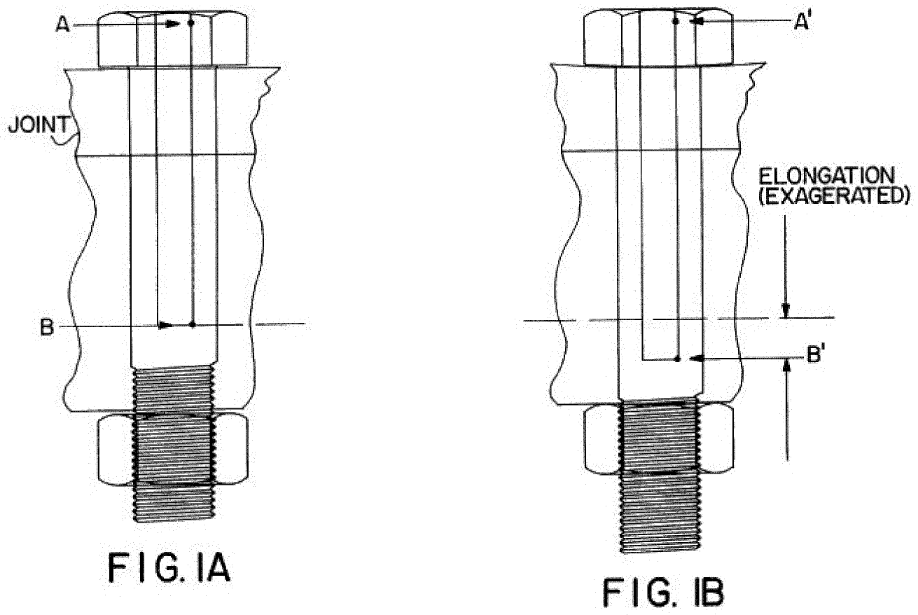

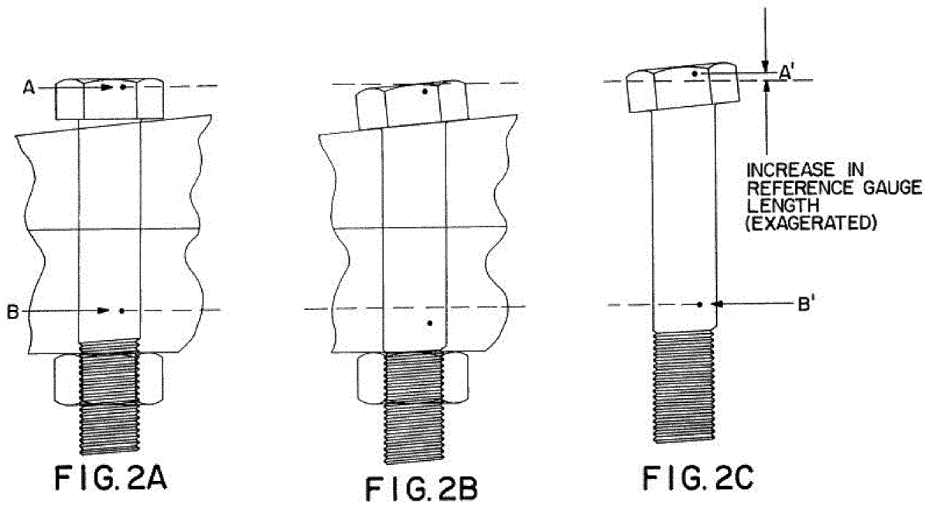

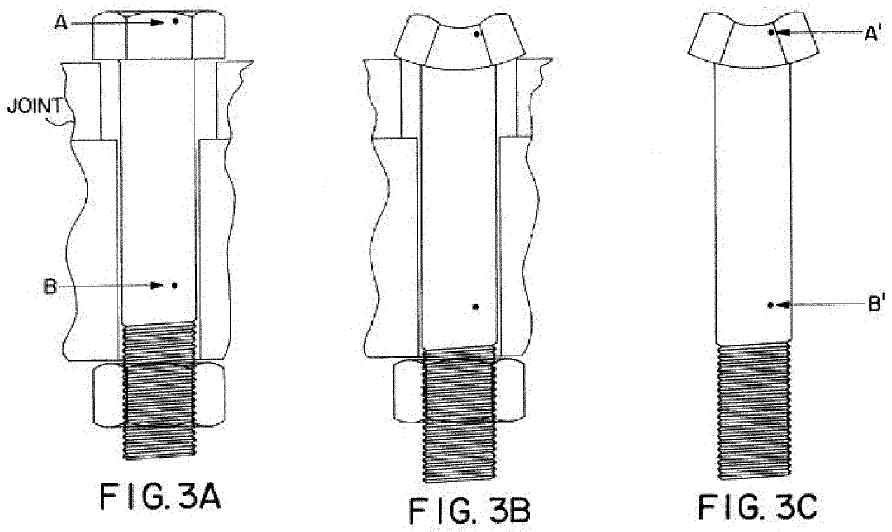

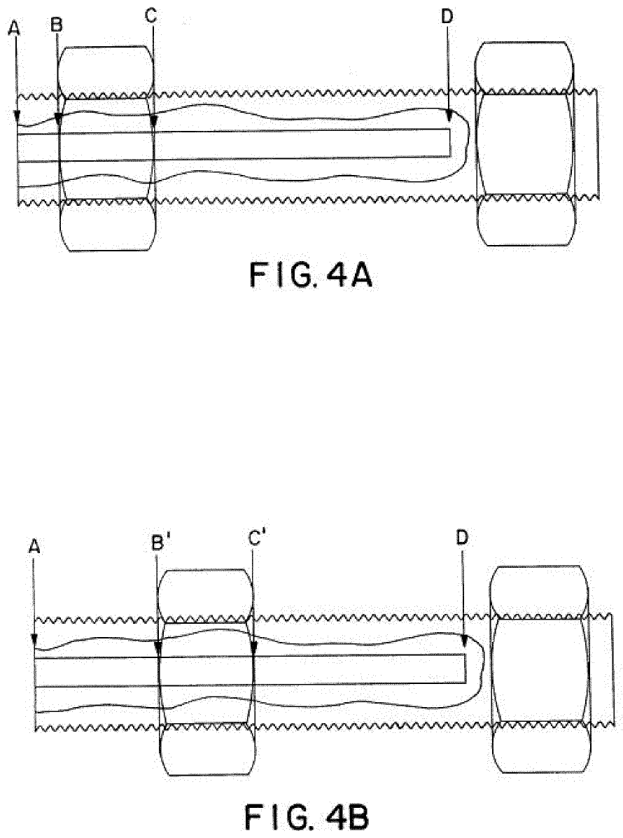

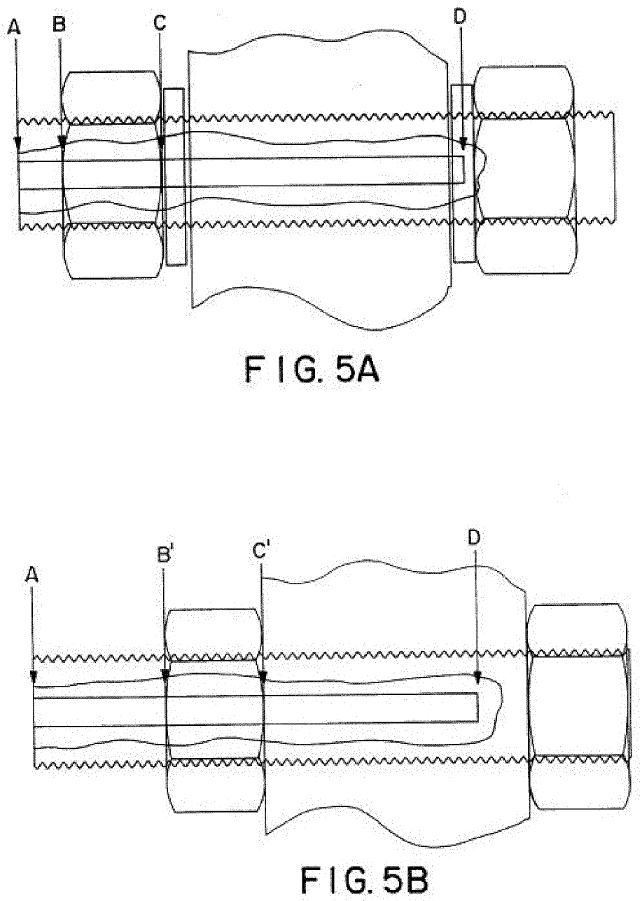

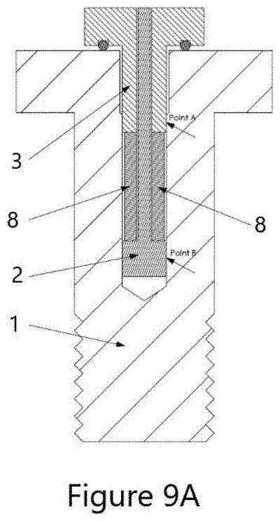

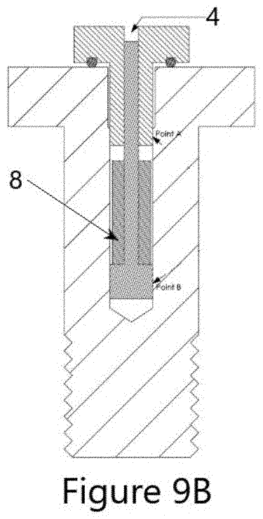

FIGS. 9A and 9B show a three-piece assembly which has a tubular base 3, gauge pin 2, and also a spacer 8. This assembly works similar to the assembly in FIG. 6, however, rather than the tubular base 3 bearing directly against the gauge pin 2, the tubular base 3 may bear against the spacer 8 which may simultaneously bear against the gauge pin 2. One possible advantage of this embodiment is that it could be less expensive to manufacture than a longer base piece shown in FIG. 1. Another advantage is that the spacer 8 could easily be modified to different lengths allowing the apparatus to be customized for different applications. For example if it was desirable to have a longer distance between PT. A and PT. B, the apparatus could be customized by using a standard tubular base piece 3 in conjunction with a longer gauge pin 2 and a longer spacer 8.

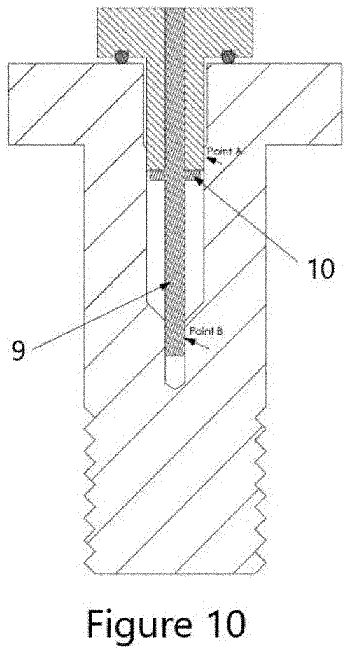

FIG. 10 shows a gauge pin 9 with a symmetrical protrusion 10 attached to, or a part of, the gauge pin 9, causing interference such that the appropriate distance between PT. A and PT. B (where the gauge pin 9 is attached) may be achieved upon installation.

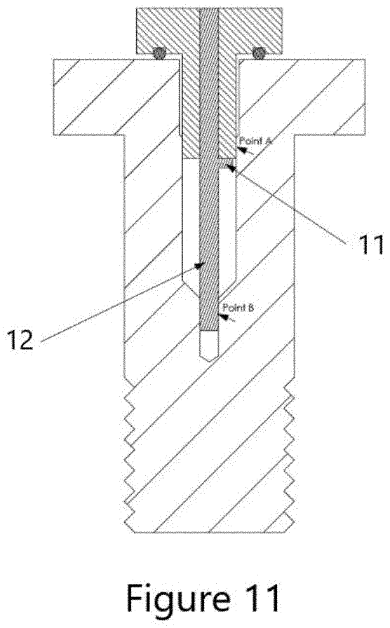

FIG. 11 shows a gauge pin 11 with a non-symmetrical protrusion 12 attached to the gauge pin 11, or part of, the gauge pin 11, causing interference such that the appropriate distance between PT. A and PT. B (where the gauge pin 11 is attached) may be achieved upon installation.

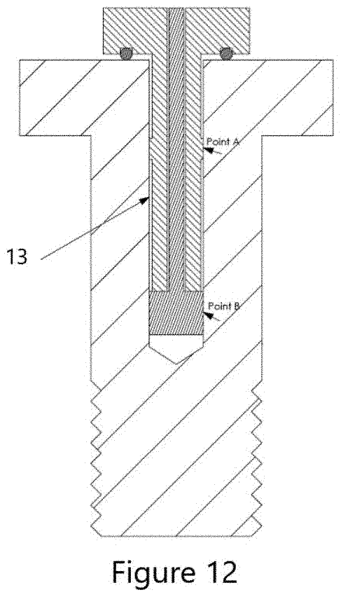

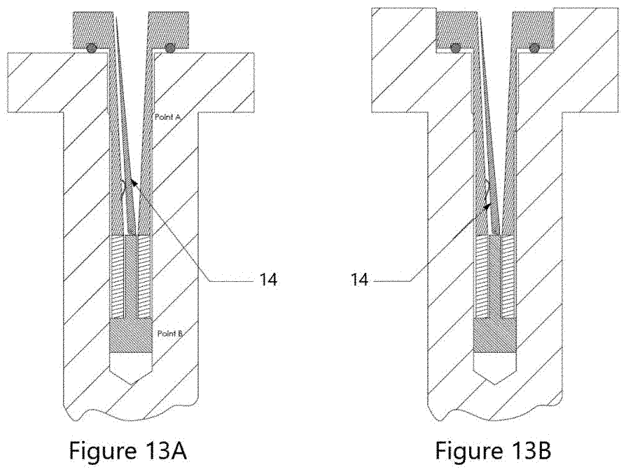

FIG. 12 shows an embodiment where the entire apparatus could be inserted into a single diameter central bore within the fastener 13. In this embodiment the machining of the fastener 13 could be as simple as drilling a single diameter hole, and the installation of the apparatus could be done by a relatively unskilled layperson or machinist. This embodiment would also enable a relatively easy installation of the apparatus into a fastener while the fastener was in an installation in the field.

FIG. 13A and FIG. 13B show an embodiment where the apparatus has a mechanical indicator 14 built into the tensile member 1. The mechanical indicator 14 could, for example, be the apparatus described in U.S. Pat. No. 5,668,323 issued to the present inventor and sold on the market today as the Maxbolt™. Rather than using a mechanical indicator, an electronic indicator or sensor could be used within the fastener in a similar manner.

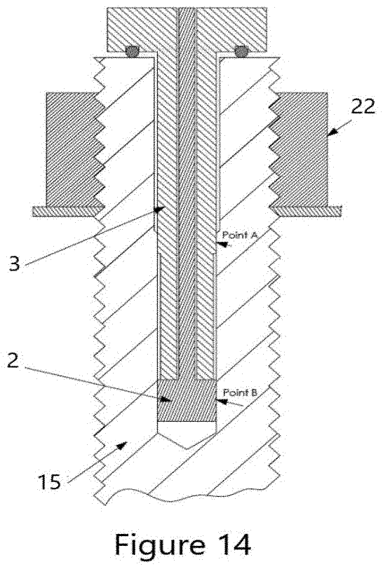

FIG. 14 shows and embodiment where the apparatus is installed in a threaded stud 15. In this configuration it would be possible to install the apparatus such that PT. A where the tubular base piece 3 is attached is below the bottom of the nut 22 in order to reduce or eliminate well known errors caused due to unknown strain in the region of the fastener where it is engaged with the nut.

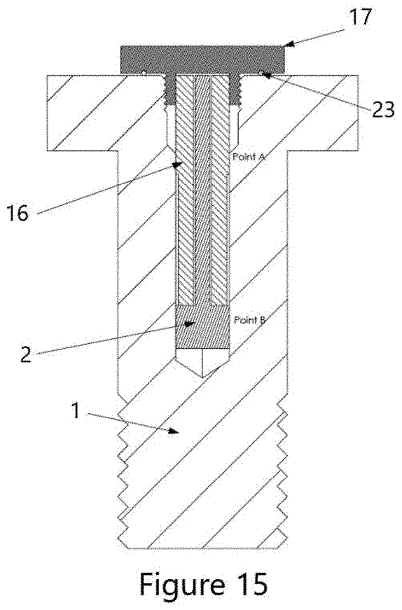

FIG. 15 shows and embodiment where a tubular base 16 does not protrude beyond the end of the fastener. In some installations this would reduce the risk of the tubular base being damaged. In this embodiment there could be a protective cap 17 attached directly to the fastener as shown or attached to the tubular base piece 3. In this embodiment, a sensor could attach to a modified housing that in turn is attached to the tubular base 16 in a way that better accommodates this embodiment such as by using the central bore to help position the housing or by using a magnetic force to attach a sensor housing to the tubular base 16. This embodiment also shows a possible position of a sealing o-ring 23 under the protective cap 17.

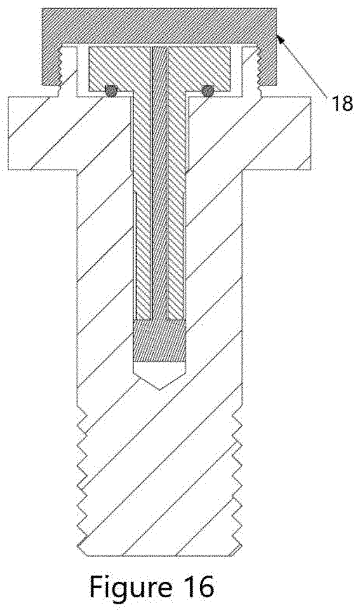

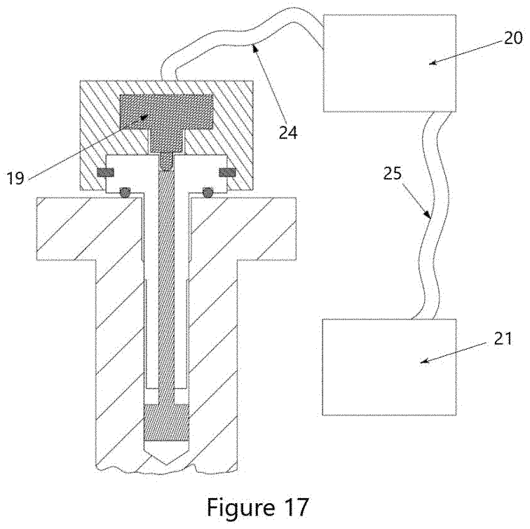

FIG. 16 shows and embodiment with a protective cap 18 that may be plastic, metallic, or some other appropriate material. The cap could be sealed with o-rings and it could attached with a threaded interface, or snap on, or attach through other means.

FIG. 17 shows and embodiment in which the apparatus could include an attached sensor 19 that sends out a signal through a wire 24 or wirelessly, such as bluetooth or other electromagnetic wave frequencies, that is received by an electronic receiving device 20 such as a smartphone, computer, or other receiver. The received data could be stored or displayed in order to record a history, or current state, of the tension in the fastener, or to set off an alert if the tension deviated from a predetermined range, or to provide other information about the assembly to ensure optimal performance, longevity and safety. The data could also be used to control a tightening device 21 such as a hydraulic torque wrench so that the fastener achieved a desired tension. The connection between the electronic receiving device 20 and the tightening device 21 could be a wire 25 or wirelessly.

In various additional embodiments the apparatus could include an additional device to receive data from multiple fasteners in an assembly, wherein these data are used to determine, and then inform the user of, a preferred tightening procedure. The procedure could be continually updated as the fasteners are being tightened in the assembly. Since tightening one fastener in an assembly can affect the tension in neighboring fasteners, the device could use the real time data, as well as the historical data, to determine a preferred tightening procedure that could include details of which fasteners to tighten and how much to tighten them. The means by which this embodiment would determine the preferred tightening procedure would involve a computer program or smartphone app that could consider many possible variables, such as the desired tensions, fastener proof loads, temperatures, desired differences in tensions, real time data regarding the dynamic tensions and how fasteners affect one another, and other variables. These programs or phone apps could be easily customized by the manufacturer or end user depending upon their needs and the available tightening equipment. These programs could also connect to, and control, a torque wrench or other type of tightening equipment.

In various embodiments the apparatus could include a visual or audible signal emitter on the apparatus such that a light or sound or color change or some other means of alert was emitted when the tension deviated from a predetermined range.

In various embodiments the apparatus could include a receptacle on the sensor or sensor housing for holding the protective cap. The sensor or sensor housing could hold the cap in many ways; for example, the sensor or sensor housing could have a magnet that attracted a metallic metal cap or it could have a face or protrusion similar to the tubular base piece or the fastener head and the cap could attach to the sensor using the same process that it attaches to the load indicating fastener or tubular base.

In various embodiments of the apparatus the upper surface of the gauge pin 2 and the upper surface of the tubular base 3 are not necessarily flush with one another upon installation in the untensioned fastener 1.

In various embodiments of the apparatus, one of, or both, the gauge pin 2 and the tubular base 3 could be attached to the internal bore through various means such as an adhesive, welding, threads, press fit, or interference fit. Adhesive bonding methods could involve anaerobic processes as well as exposure to chemicals, light, or certain temperatures.

In various embodiments the apparatus could have many methods and coverings to protect the surfaces from moisture and dirt. One method of protection could include the use of a flexible or non-flexible sealant used to prevent moisture from entering the apparatus rather than, or in addition to, o-rings. Internal gaps or spaces could be filled with an inert or rust protecting substance such as grease.

In various embodiments the apparatus could be used to monitor tension and load in a non-threaded fastener or tensile member used to join two or more parts of an assembly and used to support another object such as with a crane hook.

In additional various embodiments, in order to aid in anchoring the gauge pin at point B, the gauge pin could be comprised of 2 or more pieces. For example in order to attach the gauge pin at point B, a lower section of the gauge pin could be comprised of an expanding section that expands outward and anchors to the fastener as the gauge pin is pressed into the fastener. Such expanding sleeves are used throughout industry and are similar to a sleeve that is commonly used to anchor screws or nails in drywall or concrete. This expanding press fit can be achieved in many ways and can be used to attach the gauge pin as well as attach the tubular base. This expansion attachment method could also be driven by forces applied by a spacer similar to the spacer that was described with FIG. 9 but modified to drive the expansion of the sleeve.

1. An apparatus for measuring tensile load in a fastener, the apparatus comprising:
a tubular base piece and a gauge pin;
the tubular base piece comprising:
a male coupler on the head of the tubular base piece;
an inner diameter;
the gauge pin comprising:
a first section having a diameter less than the inner diameter of the tubular base piece;
a second section with radial dimension that exceeds the inner diameter of the tubular base piece;
an end section configured to attach within a central bore of a fastener.

2. The apparatus of claim 1, wherein the gauge pin has a second section that bears against the tubular base piece in order to maintains a predetermined distance between the end section of the gauge pin configured to attach within a central bore of a fastener and an outer diameter of the tubular base piece configured to attach within the central bore of the fastener.

3. The apparatus of claim 1, wherein the tubular base piece and the gauge pin are configured to be attached within a central bore of a fastener in order to measure the strain of a known region of the fastener.
